(19) United States
(12) Patent Application Publication
(10) Pub. No.: US 2026/0029264 A1
(43) Pub. Date: Jan. 29, 2026

(54) THERMAL ANEMOMETRY METHOD AND THERMAL ANEMOMETER FOR MEASURING A FLOW VELOCITY OF A FLOWING FLUID AT A HIGH TEMPORAL RESOLUTION

(71) Applicant: Max-Planck-Gesellschaft zur Förderung der Wissenschaften e.V., München (DE)

(72) Inventor: Holger Nobach, Göttingen (DE)

(73) Assignee: Max-Planck-Gesellschaft zur Förderung der Wissenschaften e.V., München (DE)

(21) Appl. No.: 19/347,419

(22) Filed: Oct. 1, 2025

Related U.S. Application Data
(63) Continuation of application No. PCT/EP2023/059236, filed on Apr. 6, 2023.

(51) Int. Cl. G01F 1/69

(52) U.S. Cl. CPC G01F 1/69

(57) ABSTRACT

In a thermal anemometry method of measuring a flow velocity of a flowing fluid, a probe is arranged in the flowing fluid. An electric current is passed through the probe to heat up the probe to a temperature that is higher than an ambient temperature. An amperage of the electric current through the heated probe and a voltage dropping over the heated probe are measured, while the electric current heating up the probe is passed through the heated probe. The flow velocity is determined using the temperature of the heated probe, a change in the temperature of the heated probe and an electric power supplied to the heated probe by the electric current, which are all determined from the amperage and the voltage, and using a heat capacity of the heated probe.

### CROSS REFERENCE TO RELATED APPLICATIONS

This application is a continuation of International Application PCT/EP2023/059236 with an international filing date of Apr. 6, 2023, the disclosure of which is incorporated herein by reference in its entirety.

### FIELD OF THE INVENTION

The present invention relates to a thermal anemometry method of measuring a flow velocity of a flowing fluid and to a thermal anemometer for carrying out such a method.

### BACKGROUND OF THE INVENTION

C. Tropea et al. Eds.: Handbook of Experimental Fluid Mechanics, Springer-Verlag Berlin Heidelberg 2007, Part B, Measurement of Primary Quantities, 5.2 Thermal Anemometry, disclose thermal or hot-wire anemometry as a versatile technique that can be used for the measurement of rapidly varying flow velocities in turbulent flows with good spatial and temporal resolution. Thermal anemometry relies on the change in heat transfer from a small heated probe exposed to the fluid in motion. The probe is made of a material whose electric resistivity depends on the temperature. Usually, the probe has the shape of small cylindrical wire or a thin film. Heat is introduced in the probe by Joule heating, and is lost primarily by forced convection. The rate of heat flow into the probe or heating rate is the electric power of the electric current passed through the probe. The rate of heat flow out of the probe or cooling rate depends on a temperature difference between the temperature of the heated probe and the ambient temperature and on the flow velocity to be measured. The ambient temperature is the temperature of the probe at the same location when not heated. Usually, the ambient temperature is the temperature of the fluid whose flow velocity is to be measured. The cooling rate is the temperature difference multiplied by a function of the flow velocity normal to the direction of main extension of the probe. In the instantaneous heat balance of the heated probe, the change in temperature of the probe multiplied by the mass of the probe and the specific heat of the probe material equals the difference between the heating rate and the cooling rate.

The Handbook of Experimental Fluid Mechanics reports three different operating modes of the probe in thermal anemometry. In a constant current anemometer (CCA), the current intensity or amperage in the probe is maintained constant. The flow velocity is derived from a resulting change in the voltage dropping across the sensor. In a constant temperature anemometer (CTA) the resistance and, thus the temperature of the probe is kept constant. The flow velocity is derived from the resulting change in power of the electric current which, due to the constant resistance of the probe can be derived from the amperage of the electric current through and or the voltage dropping across the probe. In a constant voltage anemometer (CVA) the voltage across the probe is maintained constant. The flow velocity is derived from the resulting change in amperage of the electric current through the probe. In all these three anemometers, the dependency of the flow velocity of interest on the measured quantity is to be determined by calibration of the respective probe.

Further, a constant power anemometer (CPA) is known in which the heating rate, i.e. the electrical power being the product of the amperage of the electric current trough the probe and the voltage dropping over the probe, is maintained constant. Here, the flow velocity is derived from a change in the amperage or the voltage.

In the use of all these anemometers, it becomes apparent that the rebalancing needs some time to adapt to a change in flow velocity, i.e. to a change in the cooling rate depending on the flow velocity. The operation mode of the respective anemometer only works, if the respective physical quantity is in fact constant. Thus, even with a fast controller of the respective anemometer, the temporal resolution achieved in measuring the fluid flow is limited.

In a thermal anemometry method according to J. F. Foss et al.: The thermal transient anemometer, Meas. Sci. Technol. 15 (2004) 2248-2255, a thermal transient anemometer (TTA) is used for measuring a flow velocity spatially averaged over a given area segment. The operating principal is characterized as follows: (i) elevate the temperature of a multi-X pattern sensor that appropriately samples the area of interest to an initial overheat condition, (ii) allow the sensor to cool by the heat transfer of the passing fluid, (iii) execute a calibration such that the exponential decay of the sensor resistance can be characterized by a time constant, and (iv) infer the spatially averaged flow velocity from the time constant and calibration data. The thermal transient anemometer does in fact not only average spatially but also temporally as the time constant characterizing the exponential decay of the sensor resistance is determined from resistance data measured over an extended period of time. Thus, the thermal transient anemometer has a particularly low temporal resolution with respect to changing flow velocities.

There still is a need of a thermal anemometry method and a corresponding thermal anemometer which allow for a particularly high temporal resolution in measuring changing flow velocities of a flowing fluid.

### SUMMARY OF THE INVENTION

The present invention relates to a thermal anemometry method of measuring a flow velocity of a flowing fluid. The method comprises arranging a probe in a flowing fluid, passing an electric current through the probe to heat up the probe to a temperature that is higher than an ambient temperature, measuring an amperage of the electric current through the heated probe and a voltage dropping over the heated probe, while the electric current heating up the probe is passed through the heated probe, and determining a temperature of the heated probe, a change in the temperature of the heated probe and an electric power supplied to the heated probe by the electric current during the change in the temperature of the heated probe from the amperage measured and the voltage measured. The method further comprises determining a flow velocity of the flowing fluid using the temperature of the heated probe, the change in the temperature of the heated probe, the electric power supplied to the heated probe and a heat capacity of the heated probe.

The present invention also relates to a thermal anemometer for measuring a flow velocity of a flowing fluid, the thermal anemometer comprising a probe, a controller for passing an electric current through the probe, and a measure and evaluation device. The controller and the measure and evaluation device are configured for passing an electric current through the probe such as to heat up the probe to a temperature that is higher than an ambient temperature, measuring an amperage of the electric current through the heated probe and a voltage dropping over the heated probe, while the electric current heating up the probe is passed through the heated probe, determining a temperature of the heated probe, a change in the temperature of the heated probe and an electric power supplied to the heated probe by the electric current during the change in the temperature of the heated probe from the amperage measured and the voltage measured. The controller and the measure and evaluation device are further configured for determining a flow velocity of the flowing fluid using the temperature of the heated probe, the change in the temperature of the heated probe, the electric power supplied to the heated probe and a heat capacity of the heated probe.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 shows the design of a sensor having a heated probe as used in the thermal anemometry method and the thermal anemometer according to the present invention;

FIG. 2 is a diagram comparing the response of a differential temperature anemometer (DTA) according to the present invention to the responses of a constant voltage anemometer (CVA) and a constant temperature anemometer (CTA) according to the prior art;

FIG. 3 is a simplified circuit diagram of an embodiment of a DTA according to the present invention;

FIG. 4 is a simplified circuit diagram of another embodiment of the DTA according to the present invention;

FIG. 5 is a circuit diagram of a DTA used in proof of concept measurements;

FIG. 6 is a diagram showing the response of a DTA according to the present invention comprising a controller operating according to the CVA concept to a square wave change in flow velocity of a flowing fluid; and

FIG. 7 is a diagram showing the response of a DTA according the present invention comprising a controller operating according to the CTA concept to the same square wave change in flow velocity as in FIG. 6.

### DETAILED DESCRIPTION

In the present thermal anemometry method of measuring a flow velocity of a flowing fluid, a probe is arranged in the flowing fluid, an electric current is passed through the probe to heat up the probe to an increased temperature that is higher than an ambient temperature, and an amperage of the electric current through the heated probe and a voltage dropping over the heated probe are measured, while the electric current heating up the heated probe is passed through the probe. From the amperage and the voltage measured, a temperature of the heated probe, a change in temperature of the heated probe and an electric power supplied to the heated probe by the electric current during the change in the temperature of the heated probe are determined. The velocity of the flowing fluid is determined using the electric power of the electric current, and the temperature, the change in the temperature and a heat capacity of the heated probe.

The present thermal anemometry method utilizes the instantaneous temperature response of the heated probe to a change in the flow velocity, i.e. the resulting temperature difference or differential quotient dTw/dt. Therefore, the inventor designates the present thermal anemometry method as differential temperature anemometry and a corresponding thermal anemometer as a differential temperature anemometer (DTA). in contrast to the thermal anemometers known as CCA, CTA, CVA and CPA, no equilibrium between the cooling rate caused by the fluid flowing at the flow velocity of interest and the heating rate caused by the electric current through the heated probe has to be achieved before the flow velocity can be determined. In contrast to a TTA, the temperature and the change in temperature of the heated probe are determined from the measured voltage and amperage, while the heated probe is purposefully heated by the electric current, and no time constant of a decay of the temperature of the heated probe is determined but any instantaneous change in temperature is evaluated. As a consequence, the new DTA already provides a new, i.e. updated flow velocity during a resulting change in temperature, i.e. at a time which is a dead time of all conventional anemometers. When compared to a TTA, the temporal resolution achieved by the DTA is also increased as the DTA does not inherently average the flow velocity temporally. Actually, the temporal resolution of the DTA is only limited by the sample rate at which the amperage of the electric current through the heated probe and the voltage dropping over the heated probe are measured and by any noise affecting these measurements.

The core feature of the present thermal anemometry method may also be defined in that a momentary value of the flow velocity of the flowing fluid is determined using a momentary change in the temperature of the heated probe and a momentary value of the electric power which is the product of the amperage of the electric current through and the voltage dropping across the heated probe. This core feature ensures that the method according to present invention even works during an instantaneous heat imbalance between the heating rate and the cooling rate of the heated probe. In other words, the amperage and the voltage from which the flow velocity is determined are measured while the temperature of the heated probe is changing due to a change in the flow velocity of the flowing fluid.

The feature of the present thermal anemometry method that the electric current is passed through the heated probe to heat up the heated probe to the increased temperature that is higher than the ambient temperature does not include any limitation that the increased temperature or any other physical quantity of the heated probe is controlled such as to keep it constant. Nevertheless, the electric current may be controlled such as to keep a physical quantity of the heated probe constant. This physical quantity may be the temperature of the heated probe like in a CTA, the amperage of the electric current through the heated probe like in a CCA, the voltage dropping over the heated probe like in a CVA or the electric power supplied to the heated probe by the electric current like in a CPA. The controller seeking to keep the physical quantity of the heated probe constant may be a rather simple and slow controller, as the present thermal anemometry method is not dependent on that the physical quantity is actually kept constant. Particularly, the present method already provides the flow velocity of interest before the respective physical quantity, after a change in the flow velocity, is constant again. Once, the respective physical quantity is constant again, the flow velocity may be measured like in a standard CTA, CCA, CVA or CPA. However, the present method also works with constant as well as with drifting physical quantities.

In the present thermal anemometry method, the electric current passed through the heated probe may be repeatedly modulated, preferably periodically. This modulation, for example, allows for using lock-in methods in measuring the flow velocity in order to suppress the influence of noise on the measured amperage and voltage.

In the present thermal anemometry method the momentary value of the flow velocity v(t) may be calculated according to one of the following formulas:

$$g ( v ( t ) ) = ( Pw - Cw dTw / dt ) / ( Tw - Ta ) \\ v ( t ) = G ( ( Pw - Cw dTw / dt ) / ( Tw - Ta )$$

Here, Pw is the electric power of the electric current heating up the probe, i.e. the heating rate. Cw is the thermal capacity of the heated probe. This thermal capacity is the product of the mass of the heated probe and the specific heat of the material of the heated probe. However, rather than calculating the thermal capacity of the heated probe, it is preferred to determine the thermal capacity in calibrating the probe. dTw/dt is the change in the temperature of the heated probe. (Pw−Cw dTw/dt) is the cooling rate. Tw is the temperature of the heated probe, and Ta is the ambient temperature, i.e. the temperature to which the unheated probe would equalize. Typically, Ta is the temperature of the flowing fluid. The divisor (Tw−Ta) normes the cooling rate (Pw−Cw dTw/dt) to the difference between the temperature Tw of the heated probe and the ambient temperature Ta. g is a calibration function determined in calibrating the probe for the respective flowing fluid of the ambient temperature Ta. G is the inverse function of g and also a calibration function which can determined in calibrating the probe for the respective flowing fluid of the ambient temperature Ta. The argument of G is the normalized cooling rate ((Pw−Cw dTw/dt)/(Tw−Ta)).

In other words, in the formula given above, the thermal capacity Cw transforms the change in the temperature of the heated probe dTw/dt into a heating or cooling rate comparable to the heating rate of the electric power Pw. The division by the temperature difference of the temperatures Tw and Ta normalizes the differences in the heating or cooling rates Pw and Cw dTw/dt to the present temperature of the heated probe so far as exceeding the ambient temperature. Via the calibration function G, the normalized difference between the heating or cooling rates is directly indicative of the flow velocity v(t) of interest.

The ambient temperature Ta has an influence on the heat transport from the heated probe to the flowing fluid, i.e. the cooling rate. Preferably, the ambient temperature Ta is maintained constant. Alternatively or additionally, the ambient temperature may be measured to improve the accuracy of the measurement of the flow velocity. Large variations of the ambient temperature Ta lead to changes in density and viscosity of the flowing fluid, which may lead to deviations from the function G determined for a particular ambient temperature Ta. An additional unheated probe in contact to the ambient, i.e. to the flowing fluid may be used to measure the ambient temperature by measuring the momentary value of the electric resistance of the unheated probe.

As usual in thermal anemometry, the flow velocity measured by the present thermal anemometry method is no vector but an absolute value. Basically, this absolute value is indicative of a convection velocity caused by the fluid flowing at its present flow velocity in its present flow direction. If the flow direction is known, the heated probe may be calibrated for this flow direction such that the flow velocity measured is absolute value of the flow velocity in this flow direction. The present thermal anemometry method has its maximum sensitivity, if the heated probe is oriented at a right angle to and free of obstructions in the flow direction in which the fluid is flowing. As known in thermal anemometry, the flow velocity of an unknown or changing flow direction may be measured using a sensor with multiple probes.

A thermal anemometer for carrying out the present thermal anemometry method, i.e. a DTA, comprises a probe, a controller for passing an electric current through the probe, and a measure and evaluation device. The controller and the measure and evaluation device are configured for carrying out the present method to measure the flow velocity of interest.

In so far as a “probe” or “heated probe” is mentioned in the present specification and the accompanying claims, this term refers to probes of any shape. Thus, the heated probe may, for example, be any one of a wire-shaped hot-wire probe, a heated probe made as a thin film as well as a rather point-shape probe.

In the present thermal anemometry method and the present thermal anemometer both probes having a positive temperature coefficient (PTC) and probes having a negative temperature coefficient (NTC) may be used.

With low flow velocities and a resulting low convection, the heated probe may overheat, if the power of the electric current heating the heated probe is not reduced. Therefore, the resistance of the heated probe which indicates the temperature of the heated probe should be limited. With probes having an PTC, the electric resistance of the heated probe is to be limited by an upper threshold, and with probes having a NTC, the electric resistance of the heated probe is to be limited by a lower threshold. In case that the electric current through heated probe is anyway controlled according to the regime of an CTA, i.e. to maintain the temperature of the heated probe constant, no additional overheat protection is needed.

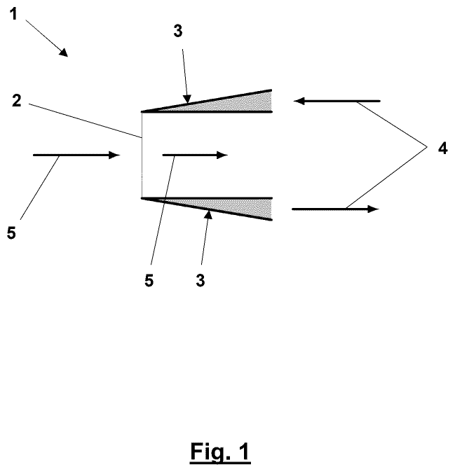

Referring now in greater detail to the drawings, the sensor 1 depicted in FIG. 1 comprises a heated probe 2 extending between and fixed to the tips of two prongs 3. The prongs 3 mechanically support and electrically connect the probe 2. The probe 2 is made of a material with a pronounced temperature coefficient, either positive or negative. The probe 2 may actually be a section of a wire with circular cross section. Alternatively, the probe 2 may be a section of a wire with any other cross section or a thin film on a substrate or of any other shape. By an electric current 4 which is passed through the probe 2, the probe 2 is heated up from an ambient temperature Ta to an increased temperature Tw. A rate of heat flow into the heated probe 2 or heating rate dQin/dt is the electric power Pw of the electric current 4, i.e. the product of an intensity or amperage of the current 4 and a voltage dropping across the heated probe 2. A rate of heat flow out of the heated probe 2 or cooling rate dQout/dt is caused by convection due to the fact that the heated probe 2 is arranged in a fluid 5 of the ambient temperature Ta. As the fluid 5 flows over the heated probe 2 at a flow velocity, the convection is a forced convection that not only depends linearly on a difference between the temperature Tw of the hot wire probe 2 and the ambient temperature Ta but also strongly on this flow velocity. Any change in the flow velocity of the flowing fluid 5 results in a change in temperature dTw/dt of the heated probe 2, and this change in temperature depends on the electric power Pw of the electric current 4.

The present method makes use of these interrelations and monitors the rate of heat flow dQout/dt out of the heated probe 2 due to the forced convection normalized to the temperature difference between the temperature Tw of the heated probe and the ambient temperature Ta, as this normalized rate of heat flow is directly indicative of the flow velocity of the flowing fluid 5. The monitored quantity, i.e. the rate of heat flow out of the heated probe 2, is determined as the difference between the rate of heat flow dQin/dt into the heated probe 2, that is equal to the electric power Pw supplied to the heated probe 2 by passing the electric current 4 there through, and a measured change in temperature dTw/dt of the heated probe 2 multiplied with a thermal capacity Cw of the heated probe 2.

More particularly, the rate of the convective heat flow dQout/dt out of the hot wire probe 2 depends linearly on the temperature difference Tw-Ta between the hot wire probe 2 and the fluid 5, the density and the specific heat capacity of the fluid, its flow velocity and an effective thickness of the boundary layer on the hot wire probe 2, which, unfortunately, also depends on the flow velocity, is non-linear and needs calibration. Losses through heat conduction through the prongs 3 or radiation from the hot wire probe 2 may be neglected. Observing and keeping the fluid characteristics constant, and acquiring the relevant electrical quantities yields the required information on the flow velocity using a specific calibration function g(v), which relates the measurements of the electrical quantities to the flow velocity v.

The measurement is not based on an equilibrium between the rate of the convective heat flow dQout/dt and the rate of heat flow dQin/dt due to the electric heating, but utilizes the change in the wire temperature dTw/dt to determine the imbalance between the electric heating and the instantaneous convection. Measuring the electric power Pw and the wire temperature Tw at a suitably high temporal resolution allows to obtain the rate of the convective heat flow dQout/dt from the change in the wire temperature dTw/dt according to

$$dQout / dt = dQin / dt - Cw dTw / dt$$

Here, Cw is the heat capacity or thermal mass of the heated probe 2. Cw is a specific constant for the hot wire probe 2 which must be determined beforehand. It may be derived from the geometry and the material of the hot wire probe 2. Alternatively, it also can be obtained during calibration of the hot wire probe 2.

Further, the rate of convective heat flow dQout/dt is normalized to the temperature difference Tw−Ta between the temperature Tw of the heated probe 2 and the ambient temperature Ta:

$$dQout / dt / ( Tw - Ta ) = ( dQin / dt - Cw dTw / dt // ( Tw - Ta )$$

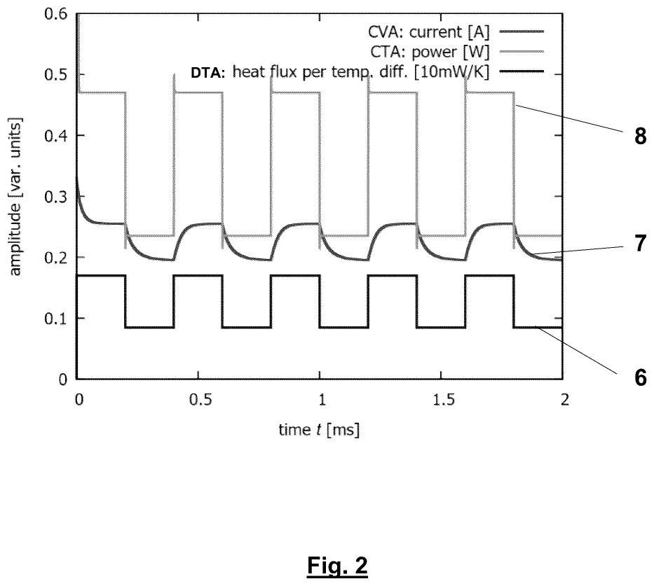

FIG. 2 shows the improvement achieved by the flow velocity determination according to the present disclosure denoted as differential temperature anemometer (DTA) in a comparison to conventional thermal anemometers. More particular, FIG. 2 is a diagram showing responses to a square wave variation of the flow velocity of the flowing fluid 5. The DTA response 6 is the resulting rate of heat flow dQout/dt out of the heated probe 2 due to forced convection normalized to the temperature difference Tw−Ta between the temperature Tw of the heated probe 2 and the ambient temperature Ta. The DTA response 6 shows the same square wave as the original variation in the flow velocity of the flowing fluid 5. In other words, the simulated square wave flow is reproduced without any distortions. Thus, the DTA response 6 indicates the momentary value of the flow velocity at a maximum temporal resolution. A CVA response 7 shows the current supplied to the heated probe 2 in a constant voltage anemometer (CVA) in which the voltage dropping over the heated probe 2 is kept constant. The whole system needs some time to restore the heat balance, and only the final value of the respective current supplied to the heated probe 2 is indicative of the momentary value of the flow velocity of the flowing fluid 5. Thus, it is apparent that the CVA response 7 indicates the momentary value of the flow velocity of the flowing fluid 5 at a limited temporal resolution only. A CTA response 8 shows the variation of the electric power Pw supplied to the heated probe 2 by the electric current 4 in a constant temperature anemometer (CTA) in which the electric current 4 is controlled such as to keep the temperature Tw of the heated probe 2 constant. Although the electrical power needed to keep the temperature of the heated probe 2 constant is reached much quicker than the restoration of the heat balance in CVA, the CTA response 8 clearly deviates from the square wave DTA response 6 as the power, at the beginning of each square of the square wave, overshoots to react on the initial temperature change.

Since the determination of the heat imbalance needs both, the change in temperature dTw/dt and the temperature Tw of the heated probe 2, the relation between the electric resistance of the heated probe 2 and its temperature Tw needs good calibration. The relation depends on the material and the geometry of the heated probe 2 and its electrical contacts. However, this calibration or modelling is required only once before the measurement, and it can be part of the manufacture of the DTA. The same applies to the measurement of the ambient temperature Ta if done with another resistive probe. The DTA using the heat balance equation dQout/dt=dQin/dt−Cw dTw/dt, see above, permanently measures dQin/dt=Pw. The other two terms are used to define the required calibration procedures by discriminating the individual terms in that the other term is set to zero. Therefore, once having determined the relation between the temperature Tw and the electric resistance of the heated probe 2, the calibration for flow measurements is done in two steps.

In the first step, dQout/dt is determined for various flow velocities v of the flowing fluid 5 while dQin/dt=Pw is measured and the wire temperature Tw is kept constant (dTw/dt=0). Fortunately, this is the same calibration procedure, and it can be performed with the same equipment as for a conventional CVA, CCA, CTA or CPA. The calibration equipment provides various defined flow velocities v and dQin/dt=Pw is measured in the equilibrium state with a constant wire temperature Tw. These measurements result in a preliminary calibration function f(v). Further, the temperature difference between the wire temperature Tw and the ambient temperature Ta is determined for all sample points of the calibration curve

$$g ( v ) = f ( v ) / ( Tw ( v ) - Ta )$$

wherein Tw(v) is the wire temperature at a given flow velocity v in the equilibrium state.

In the second step, the change in temperature dTw/dt is determined, while the heated probe 2 is heated with the electric power Pw and dQout/dt is zero. These conditions can be met by heating the heated probe 2 for a limited time without applying a flow, having the heated probe 2 thermally isolated, but without adding any heat capacity to the heated probe 2. From this measurement the heat capacity Cw of the heated probe 2 can be obtained according to

$$Cw = Pw / dTw / dt .$$

This calibration is required only once for a given probe 2, and it may be part of its manufacture. Alternatively, the heat capacity can be calculated form the geometry and the material of the probe 2.

One advantage of the DTA is that it may use existing measurement circuitry, like that one of a CVA, a CCA, a CTA or a CPA. The only addition which may be needed is the simultaneous determination of the amperage of the electrical current 4 through the heated probe 2 and the voltage dropping over the heated probe 2. These two electric quantities may be measured directly. There is no need to keep any electric quantity constant, i.e. both amperage and voltage may change over time. Such a change may be used to e.g. limit the temperature of the heated probe if a too low forced convection is insufficient to cool the heated probe 2 sufficiently. Anyway, the circuitry of the DTA may be much simpler than that one of a conventional CVA, CCA, CTA or CPA, as there is no need to keep any electric quantity constant to be able to measure the flow velocity of interest.

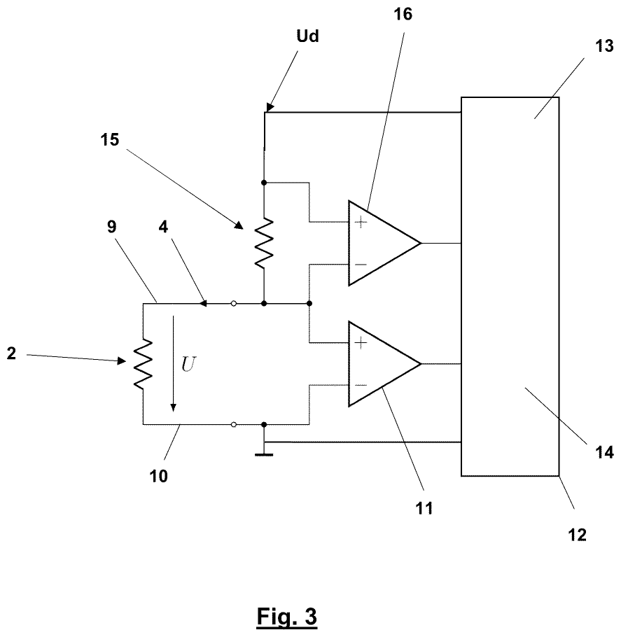

The circuit diagram according to FIG. 3 implements a two-wire measurement option in a differential temperature anemometer (DTA) according to the present disclosure. A pair of two wires 9 and 10 is used to supply the electric current 4 to the heated probe 2 and to measure the voltage U dropping across the heated probe 2. Via an instrumentation amplifier 11, these two wires 9 and 10 are connected to a unit 12 implementing a controller 13 and a measurement and evaluation device 14. The controller 13 controls the current 4 through the heated probe 2 or a voltage Ud driving this current 4 through the heated probe 2. The measure and evaluation device 14 measures the amperage of this current 4 by measuring a voltage dropping over a reference resistor 15. The reference resistor 15 is connected in series with the probe 2, and its two ends are connected to the unit 12 via a further instrumentation amplifier 16. From the values of the continuously measured amperage of the electric current 4 and the simultaneously measured voltage dropping across the heated probe 2, the power Pw, i.e. the rate of heat flow dQin/dt into the heated probe 2, is determined. Further, the temperature of Tw of the heated probe 2 and any change in temperature dTw/dt of the heated probe 2 are determined using the calibrated relation between the electric resistance of the heated probe 2 and its temperature Tw. The controller 13 may seek to keep the temperature Tw or the amperage of the electric current 4 or the voltage U dropping across the heated probe 2 or the power Pw of the electric current constant or the controller may simply care for keeping a minimum and a maximum temperature difference between the temperature Tw of the heated probe 2 and the ambient temperature Ta. The outputs of both instrumentation amplifiers 11 and 16 may be registered by respective analog-digital converters (ADCs) of the unit 12.

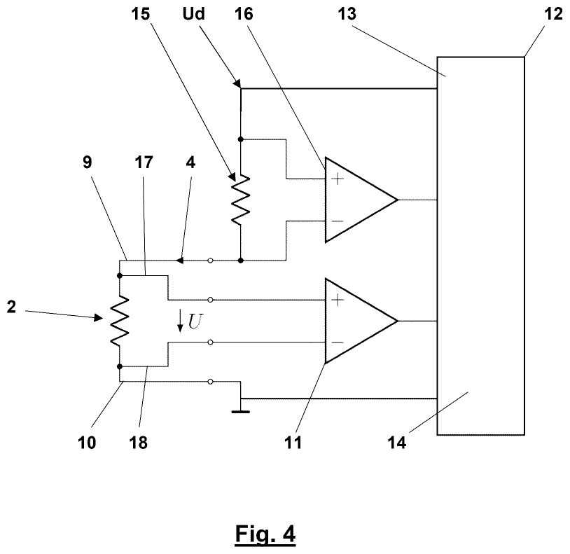

FIG. 4 shows a variant of the circuitry according to FIG. 3 implementing a four-wire measurement option in which a separate pair of wires 17 and 18 is connected to the probe 2 for measuring the voltage U dropping across the heated probe 2. This improves the accuracy of the voltage measurement by suppressing the influence of cable impedances of wires 9 and 10 supplying the electric current 4 to the heated probe 2.

The circuitries of both FIGS. 3 and 4 may be used with heated probes 2 having a positive temperature coefficient (PTC) or with heated probes 2 having a negative temperature coefficients (NTC), without any modifications. Only an overheat protection circuit may have to be adapted to the sign of the temperature coefficient.

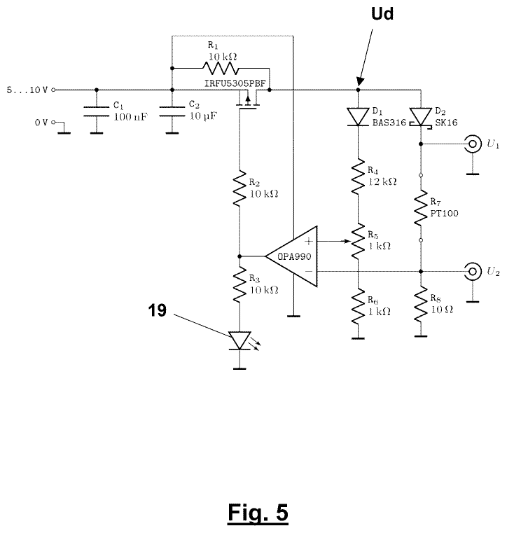

An experimental proof of concept showed that the DTA of the present disclosure can be faster than conventional CVA and CTA devices. In the proof of concept, a probe with a comparatively high thermal capacity Cw, i.e. a 4 mm×5 mm large PT100 measurement resistor, was used instead of a normal hot-wire probe. The measurement resistor was heated electrically and cooled in an air flow provided by a computer fan with a diameter of 90 mm. The flow was repeatedly applied to the measurement resistor for 20 s and then blocked for another 20 s. FIG. 5 shows the circuitry which has been used in the proof of concept. The two output voltages U1 and U2 were measured and registered by means of an USB oscilloscope PicoScope 5443B. U2 is the voltage dropping over the reference resistor R8, which is proportional to the current through a half bridge including a series connection of the measurement resistor R7 providing the probe and the reference resistor R8. U1 is the voltage over the half bridge. To obtain the voltage dropping over the measurement resistor R7, U1-U2 is calculated from the raw data. Resistors R4, R5, R6, operational amplifier OPA990, resistor R2 and the p-channel MOSFET IRFU5305PBF are parts of a temperature control loop. Diodes D1 and D2 override the offset of the OPA990, allowing for a continuous regulation of the temperature Tw of the PT100 measurement resistor R7. Resistor R1 guarantees that the control loop reaches a stable fix point at a given temperature Tw above the ambient temperature Ta. It prevents the control loop from getting stuck in the trivial fix point at zero voltage over the measurement bridge. R10 and the LED are used to indicate an overheat condition of the PT100 measurement resistor R7. Capacitors C1 and C2 stabilize the input driving voltage of between 5 V and 10 V. Providing 5 V to this circuitry, no overheat condition of the PT100 measurement resistor occurred during the proof of concept experiment. The applied voltage led to a constant voltage over the measurement bridge. This measurement regime is not exactly that one of a constant voltage anemometer, as the voltage over the measurement resistor R7 depends on the voltage drop over the reference resistor and, thus, on the current through the half bridge. However, the temporal behavior of the response is identical to that one of a CVA, only the calibration of the response amplitude varies a little. By measuring the current through the right half bridge, consisting of D2, R7 and R8, the temporal response of a CVA device can be obtained from the present control loop without overheating the measurement resistor R7. Combining the measurements of U1 and U2 and deriving all required quantities, i.e. I=U2/R8, U=U1−U2, Pw=dQin/dt=UI, Rw=R7=U/I, Tw(R) corresponding to the PT 100 material, dTw/dt=ΔTw/Δt, dQout/dt=Pw−Cw dTw/dt, g(v)=dQout/dt/(Tw−Ta), finally the response g(v) of the DTA to a flow velocity v can be obtained. The heat capacity of the PT100 resistor was estimated to be 35.5 mWs/K. The translation of g(v) into a flow velocity requires an appropriate calibration, which has not been performed in the proof of concept experiment.

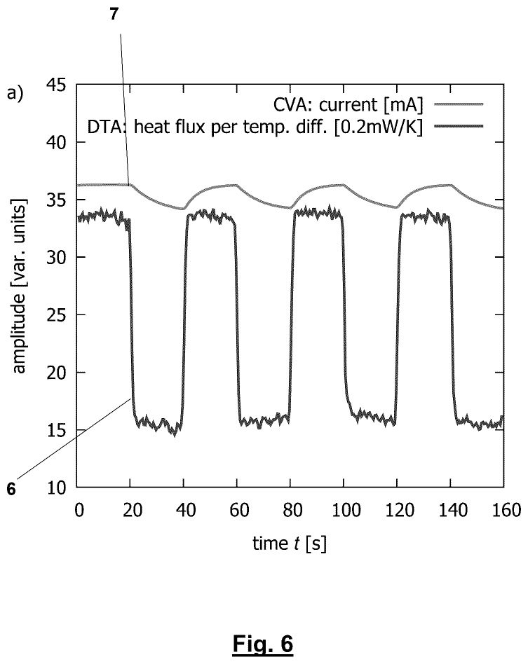

FIG. 6 shows the results of the CVA measurement in comparison with the results of the present DTA method using data from the same experiment. The CVA data come from the current measurement (derived from U2), and the DTA data use both the current (from U2) and the voltage over the PT100 resistor (from U1-U2). Without an appropriate calibration of g(v), the amplitudes will not correspond, because the calibration curves for the two anemometers are different. However, the strong low-pass damped character of the CVA response 7 is obvious, whereas the new measurement method provides a clear rectangular DTA response 6, corresponding to the top-hat like flow applied to the measurement resistor R7. The data sequence registered with the USB oscilloscope is significantly influenced by noise and needed massive oversampling and averaging for further processing. The primary data have been obtained at a sample rate of 10 kHz, whereas the data sequence, which has been used for the further processing has been reduced to a 10 Hz sampling rate.

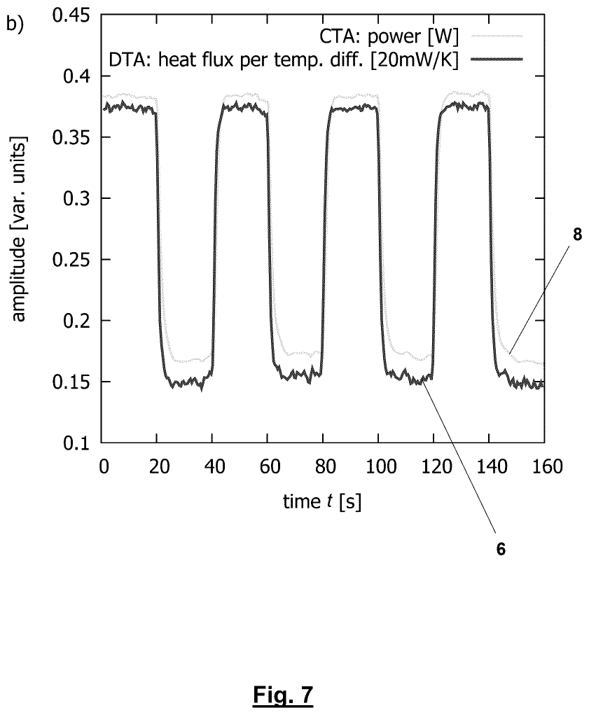

Providing 10 V to the circuitry would lead to permanently overheating the PT100 measurement resistor R7. The control loop limits the temperature of the PT100. Calculating the power needed to keep the temperature of the PT100 constant from U and I results in a measurement output similar to that one of a CTA. Again, all physical quantities for the DTA according to the present disclosure can be derived from U and I using the same data. FIG. 7 compares the power measurement for the CTA measurement regime with the response of the new measurement method. Again, the amplitudes of the two curves compared do not correspond, since both processing methods require a calibration to conclude on the flow velocity, and both calibration curves are different. However, the temporal behavior of the responses is correct. As expected, the response of the CTA response 8 is much faster than the CVA response 7 in FIG. 6. Looking at the upstrokes of the changing flow velocity, the DTA response 6 according to the present disclosure does not clearly outperform the CTA response. However, the downstrokes clearly show that the CTA response 8 depends on the flow velocity and it becomes slower with lower flow velocity. In contrast to that, the DTA according to the present disclosure provides a very fast DTA response 6 independently of the present flow velocity, i.e. a better overall temporal resolution of the present flow velocity.

Note, that the DTA responses in FIGS. 6 and 7 have identical physical dimensions. However, the data have been obtained from two independent experiments. Unintended changes of the measurement position and especially the orientation of the probe in the flow may have occurred between these two experiments, which finally led to the noticeable mismatch of the amplitudes at high flow velocity.

Many variations and modifications may be made to the preferred embodiments of the invention without departing substantially from the spirit and principles of the invention. All such modifications and variations are intended to be included herein within the scope of the present invention, as defined by the following claims.

I claim:

1. A thermal anemometry method of measuring a flow velocity of a flowing fluid, the method comprising
arranging a probe in a flowing fluid,
passing an electric current through the probe to heat up the probe to a temperature that is higher than an ambient temperature,
measuring an amperage of the electric current through the heated probe and a voltage dropping over the heated probe, while the electric current heating up the probe is passed through the heated probe,
determining
a temperature of the heated probe,
a change in the temperature of the heated probe and
an electric power supplied to the heated probe by the electric current during the change in the temperature of the heated probe from the amperage measured and the voltage measured,
determining a flow velocity of the flowing fluid using the temperature of the heated probe, the change in the temperature of the heated probe, the electric power supplied to the heated probe and a heat capacity of the heated probe.

2. The thermal anemometry method of claim 1, wherein a momentary value of the flow velocity is determined using a momentary change in the temperature of the heated probe and a momentary value of the electric power supplied by the electric current to the heated probe.

3. The thermal anemometry method of claim 1, wherein the amperage and the voltage from which the flow velocity is determined are measured while the temperature of the heated probe is changing due to a change in the flow velocity of the flowing fluid.

4. The thermal anemometry method of claim 1, wherein the electric current is controlled such as to keep
the temperature of the heated probe, or
the amperage of the electric current through the heated probe, or
the voltage dropping over the heated probe, or
the electric power supplied to the heated probe constant while measuring the amperage and the voltage from which the change in the temperature of the heated probe is determined.

5. The thermal anemometry method of claim 1, wherein the electric current is repeatedly modulated.

6. The thermal anemometry method of claim 1, wherein the electric current is periodically modulated.

7. The thermal anemometry method of claim 1, wherein the flow velocity v(t) is calculated as:
$$v ( t ) = G ( ( Pw - Cw dTw / dt ) / ( Tw - Ta ) )$$
Pw being the electric power of the electric current heating up the probe,
Cw being the thermal capacity of the probe,
dTw/dt being the change in the temperature of the heated probe,
Tw being the temperature of the heated probe,
Ta being the ambient temperature, and
G being a calibration function determined in calibrating the heated probe for the flowing fluid.

8. The thermal anemometry method of claim 1, wherein the thermal capacity of the probe determined in calibrating the heated probe.

9. The thermal anemometry method of claim 1, wherein the heated probe is oriented at a right angle to a main flowing direction of the flowing fluid.

10. The thermal anemometry method of claim 1, wherein the flow velocity is measured in-more than one spatial dimension using a sensor having multiple heated probes.

11. A thermal anemometer for measuring a flow velocity of a flowing fluid, the thermal anemometer comprising
a probe,
a controller for passing an electric current through the probe, and
a measure and evaluation device,
wherein the controller and the measure and evaluation device are configured for passing an electric current through the probe such as to heat up the probe to a temperature that is higher than an ambient temperature,
measuring an amperage of the electric current through the heated probe and a voltage dropping over the heated probe, while the electric current heating up the probe is passed through the heated probe,
determining
a temperature of the heated probe,
a change in the temperature of the heated probe and
an electric power supplied to the heated probe by the electric current during the change in the temperature of the heated probe from the amperage measured and the voltage measured,
determining a flow velocity of the flowing fluid using the temperature of the heated probe, the change in the temperature of the heated probe, the electric power supplied to the heated probe and a heat capacity of the heated probe.

12. The thermal anemometer of claim 11, wherein the controller is configured for controlling the electric current such as to keep
the temperature of the heated probe, or
the amperage of the electric current through the heated probe, or
the voltage dropping over the heated probe, or
the electric power supplied to the heated probe constant while the measure and evaluation device measures the amperage and the voltage from which it determines the change in the temperature of the heated probe.
